(19) United States
(12) Patent Application Publication
(10) Pub. No.: US 2014/0146200 A1
(43) Pub. Date: May 29, 2014

(54) ENTRIES TO AN ELECTRONIC CALENDAR

(71) Applicant: RESEARCH IN MOTION LIMITED, Waterloo (CA)

(72) Inventors: Sherryl Lee Lorraine SCOTT, Toronto (CA); Scott David REEVE, Waterloo (CA); Julia Murdock THOMPSON, Kitchener (CA); Jodie Elizabeth FLETCHER, Ottawa (CA)

(73) Assignee: RESEARCH IN MOTION LIMITED, Waterloo (CA)

(21) Appl. No.: 13/687,345

(22) Filed: Nov. 28, 2012

(51) Int. Cl. H04N 5/907; G06K 9/34

(52) U.S. Cl. CPC H04N 5/907; G06K 9/34
USPC 348/231.99; 382/177; 382/179

(57) ABSTRACT

An example method of entering calendar events into an electronic calendar involves capturing a digital image of a document that contains a written calendar event; analyzing the digital image of the document containing the written calendar event to extract text information appearing on the digital image of the document; matching the extracted text information in the digital image of the written calendar event document to a date in the electronic calendar; and populating the extracted text information to at least one field of the electronic calendar associated with the date.

### BACKGROUND

Paper calendars, or other written calendars, are often used in a home setting and other settings where a whole family can easily see upcoming events and to-dos. Digital calendars are in common use in smartphones and other hand-held computing devices and provide for easy access to calendared events. Accordingly another way to populate fields of an electronic calendar with entries taken from a written calendar or other document would be useful.

### BRIEF DESCRIPTION OF THE DRAWINGS

Example embodiments of the present disclosure will be described below with reference to the included drawings such that like reference numerals may be used to refer to like elements and in which:

FIG. 1 is a front view of a hand-held device incorporating a camera and an electronic calendar in a manner consistent with certain example embodiments.

FIG. 2 is a rear view of a hand-held device incorporating a camera and an electronic calendar in a manner consistent with certain example embodiments.

FIG. 3 is an example block diagram of the hand held device consistent with certain example embodiments.

FIG. 4 depicts a template for a calendar entry consistent with certain example embodiments.

FIG. 5 illustrates capturing an image of a written calendar with a device having an integral camera in a manner consistent with certain example embodiments.

FIG. 6 depicts a date image isolated from the written calendar in a manner consistent with certain example embodiments.

FIG. 7 depicts a template with data for a date automatically populated to the template for a calendar event in a manner consistent with certain example embodiments.

FIG. 8 illustrates capturing an image of a document containing data that can be used for an electronic calendar entry with a device having an integral camera in a manner consistent with certain example embodiments.

FIG. 9 depicts a template with data for an electronic calendar date automatically populated to the template for a calendar event in a manner consistent with certain example embodiments.

FIG. 10 illustrates capturing an image of an invitation document containing data that can be used for an electronic calendar entry with a device having an integral camera in a manner consistent with certain example embodiments.

FIG. 11 illustrates capturing an image of a photograph or other non-textually informative document that can be used for initiating an electronic calendar entry with a device having an integral camera in a manner consistent with certain example embodiments.

FIG. 12 is a flow chart illustrating one method consistent with certain example embodiments.

FIG. 13 is another flow chart illustrating one method consistent with certain example embodiments.

FIG. 14, which includes FIG. 14a and FIG. 14b, is another a flow chart illustrating a method consistent with certain example embodiments.

### DETAILED DESCRIPTION

The various examples presented herein outline methods, user interfaces, and electronic devices that allow an electronic device to capture an image of a written calendar and to parse the written calendar entries into data that populates an electronic calendar.

The term “written calendar” as used herein is intended to mean a conventional paper calendar or equivalent (e.g., calendar on a whiteboard or chalkboard) in which calendar entries are entered by writing within blocks that define days or times associated with the calendar. A “written calendar entry” is an entry of an event or scheduled event (used equivalently) entered in one or more calendar dates of the written calendar. A “written calendar entry document” is any document (including but not limited to for example, a written calendar, a party invitation, a poster, a concert ticket, an appointment card, photograph etc., and not limited to having been hand-written or printed on paper) that contains information that can be associated with an event and/or that serves as a notification to a user of a calendar (i.e., a “written calendar entry” as defined above).

Recognized handwriting or text is considered to be “matched” to a calendar event if the handwriting or text contains at least information representing in text/numerical form representing a date that can be extracted from the handwriting or text and associated with the electronic calendar date. For example, “Dec. 25, 2012”, “December 25”, “12/25/12”, “12-25-2012” or “Christmas” may all be interpreted to represent a date. Where, for example, a year is not designated, the current year or next occurrence may be assumed in certain implementations, where in other implementations, the absence of a year may prompt a query to the user, as will become clear after considering the discussion to follow.

References herein to cameras, photography, imaging, capturing an image and the like are to be construed as relating to electronic cameras or other electronic imaging devices and digital images produced thereby.

An electronic calendar is a calendar that is implemented using a calendar application such as those that are often built into smartphones, tablet computers, digital assistants and the like. Such electronic calendars incorporate, among other things, certain attributes of a searchable database including database fields (also referred to as “calendar fields” or “fields”) such as start time, end time, title (or subject), location, etc. In general, such electronic smartphones used in conjunction with implementations consistent with the present discussion either have an integral camera or can receive input signals and photograph files from a camera, or can receive copies of electronic images transferred (e.g., via email) from other cameras. The term “populate” as used herein is intended to mean automatically populate or “auto-populate” in that one or more programmed processors automatically ascertains which field in an electronic calendar an item of data is most likely to be associated with and places or inserts data within that field of the electronic calendar automatically under control of the one or more programmed processors or equivalent.

Paper calendars are often used in a home setting where a whole family can easily see upcoming events and to-dos. These types of calendars allow for ease of entry and posting with multiple users in a central location. It is useful to provide an easy way of taking a paper calendar or document and translating it into a digital version that can be accessed at a location other than that of the written calendar or document.

Reference numerals may be repeated among the figures to indicate corresponding or analogous elements. Numerous details are set forth to provide an understanding of the example embodiments described herein. The example embodiments may be practiced without these details. In other instances, well-known methods, procedures, and components have not been described in detail to avoid obscuring the example embodiments described. The description is not to be considered as limited to the scope of the example embodiments described herein.

Therefore, in accordance with certain aspects of the example embodiments of the present disclosure, there is provided a method of entering calendar events into an electronic calendar involving capturing a digital image of a document that includes a written calendar event; analyzing the digital image to extract text information appearing in the digital image; matching the extracted text information to a date in the electronic calendar; and populating the extracted text information to at least one field of the electronic calendar associated with the date.

In certain example implementations of the methods disclosed herein, the matching involves finding text that identifies the calendar date, and where the at least one field of the electronic calendar is populated with at least a portion of the extracted text. In certain example implementations, the document is a written calendar and where the matching involves associating a written calendar entry associated with a date of the written calendar with a field associated with a matching date in the electronic calendar.

In certain example implementations, the method displays a query to request manual identification of text that is not recognized in the written calendar event. In certain implementations, the analyzing involves carrying out handwriting analysis to extract text from handwriting. In certain example implementations, a template is displayed for manual entry of data associated with the date in the electronic calendar. In certain example implementations, the method further involves storing the captured digital image or a link thereto in an image field of the electronic calendar, and where the captured digital image is displayed in the template for reference in carrying out manual entry of data associated with the date in the electronic calendar. In certain example implementations, the method involves storing the captured digital image to an image field of the electronic calendar.

In certain example embodiments, a device has a storage device and a digital camera is configured to capture a digital image and store the captured digital image to the storage device. At least one programmed processor has access to the storage device and is configured to: analyze a digital image of a document that includes a written calendar event to extract text information appearing in the digital image; match the extracted text information to a date in an electronic calendar; and populate the extracted text information to at least one field of the electronic calendar associated with the date.

In certain example implementations, the matching involves finding text that identifies the calendar date, and where the at least one field of the electronic calendar is populated with at least a portion of the extracted text. In certain example implementations, the document is a written calendar and where the matching involves associating a written calendar entry associated with a date of the written calendar with a field associated with a matching date in the electronic calendar. In certain example implementations, the at least one processor is further configured to display a query to request manual identification of text that is not recognized in the written calendar event. In certain example implementations, the analyzing comprises carrying out handwriting analysis to extract text from handwriting. In certain example implementations, the at least one processor is further configured to display a template for manual entry of data associated with the date in the electronic calendar. In certain example implementations, the at least one processor is further configured to store the captured digital image to an image field of the electronic calendar, and where the captured digital image is displayed in the template for reference in carrying out manual entry of data associated with the date in the electronic calendar. In certain example implementations, the processor is configured to store the captured digital image to an image field of the electronic calendar.

In certain example embodiments, a device has a storage device and a digital camera configured to capture a digital image and store the captured digital image to the storage device. At least one programmed processor is configured to: analyze a digital image of a document that includes a written calendar event to extract text information appearing in the digital image; determine whether or not the document comprises a written calendar; match the extracted text information in the digital image to a date in the electronic calendar, where if the document is not a written calendar the matching involves finding text that identifies the calendar date, and where the at least one field of the electronic calendar is populated with at least a portion of the extracted text, and where if the document is a written calendar the matching involves associating a written calendar entry associated with a date of the written calendar with a field associated with a matching date in the electronic calendar; and populate the extracted text information to at least one field of the electronic calendar associated with the date.

A method of managing an electronic calendar involves: capturing a digital image associated with a calendar event; using a processor to analyze the digital image to determine if the digital image contains text information and if so to extract the text information appearing in the digital image; the processor further determining whether at least a part of the text information matches a date; when text information is extracted and at least part of the extracted text information matches a date in the electronic calendar, the processor inserting the extracted text information to at least one field of the electronic calendar associated with the date.

In certain implementations, when text information is not extracted, the method involves the processor causing a display to present a query to request identification of the date in the electronic calendar to which the digital image is associated. In certain implementations when at least part of the extracted text information does not match a date in the electronic calendar, the processor causes a display to present a query to request identification of the date in the electronic calendar to which the digital image is associated.

A device consistent with certain implementations includes a storage device. A digital camera configured to capture a digital image and store the captured digital image to the storage device. At least one programmed processor having access to the storage device is configured to: analyze the digital image to determine if the digital image contains text information and if so to extract the text information appearing in the digital image; determine whether at least a part of the text information matches a date; when text information is extracted and at least part of the extracted text information matches a date in the electronic calendar, inserting the extracted text information to at least one field of the electronic calendar associated with the date. In certain implementations, the processor is further configured to displaying a query to request identification of the date in the electronic calendar to which the digital image is associated when a date is not extracted. In certain implementations, the processor is further configured to, when at least part of the extracted text information does not match a date in the electronic calendar, display a query to request identification of the date in the electronic calendar to which the digital image is associated. In certain implementations, the document is a written calendar and where the matching comprises associating a written calendar entry associated with a date of the written calendar with a field associated with a matching date in the electronic calendar. In certain implementations, the processor causes a display to display a query to request manual identification of text that is not recognized in the written calendar event. In certain implementations, the analyzing involves carrying out handwriting analysis to extract text from handwriting. Certain implementations further involve the processor causing a display to display a template for manual entry of data associated with the date in the electronic calendar. In certain implementations the process further involves storing in a memory the captured digital image or a link thereto as a date-specific calendar entry or otherwise to an image field of the electronic calendar, and where the captured digital image is displayed in the template for reference in carrying out manual entry of data associated with the date in the electronic calendar. Certain implementations further involve storing in a memory the captured digital image or a link thereto to an image field of the electronic calendar or as a calendar entry such that the image may be presented upon selection or display of a date to which the image is associated.

In accord with certain example implementations, the devices and methods described herein generally involve taking an electronic photographic image of the written calendar. The image created is analyzed in order to populate an electronic calendar. Using “pick up kids, dinner 6 pm” as an example all of these words would be considered keywords and would populate a calendar entry for the day they appear in the written calendar as appropriate. If there is information that has to be reconciled after the method is completed, it is managed with a query to the user or by presenting the user with a calendar template that can be edited as appropriate in order to assure that the entry is correct.

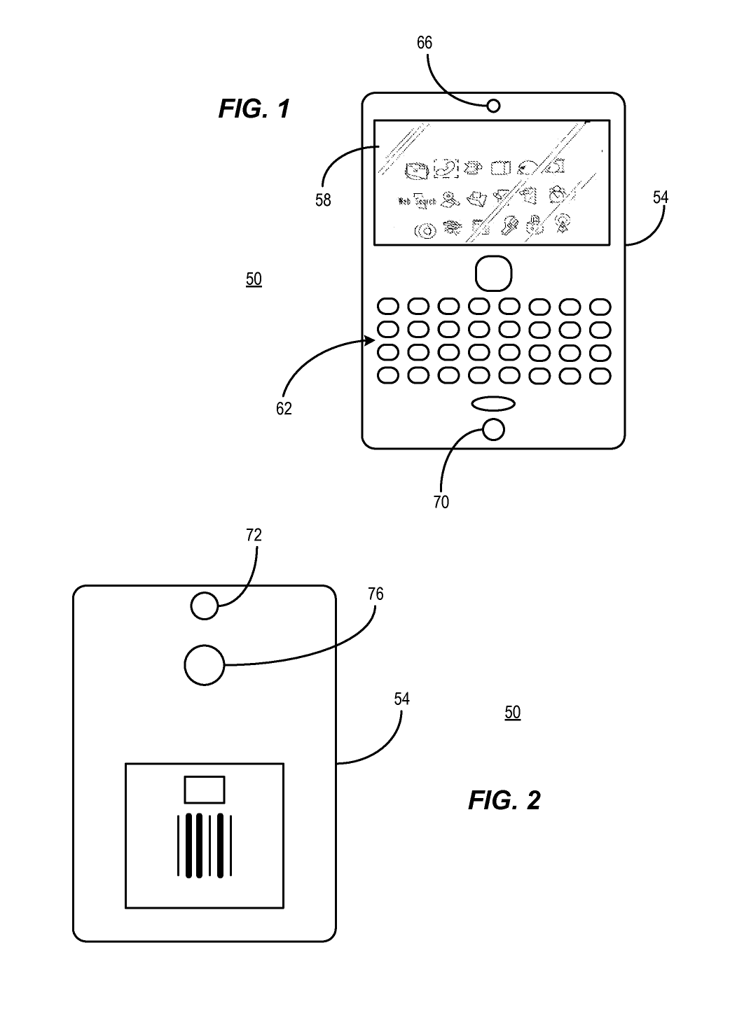

FIG. 1 is an illustration of an example embodiment of an electronic device 50 in accordance with aspects of the present disclosure. Device 50 has a housing 54 that supports a display 58. Display 58 can have one or display elements such as such as an array of light emitting diodes (LED), liquid crystals, plasma cells, or organic light emitting diodes (OLED). Other types of light emitters may be employed. Housing 54 may also support a keyboard 62 either in the form of a separate keyboard or a virtual keyboard implemented in a touch sensitive display. Device 50 also has a speaker 66 for generating audio output, and a microphone 70 for receiving audio input.

Referring to FIG. 2, an example rear view of device 50 is shown. In FIG. 2, device 50 is also shown as having an integral flash 72 and an optical capture unit (i.e., a digital camera) 76 that are used for flash or non-flash digital photography. It is to be understood that the term “optical” as used in relation to optical capture unit 76 is intended to include an array of charge coupled devices (CCD) (or a functionally equivalent optical transducer structure) that is configured, in association with a lens structure, to receive an image in the form of electro-magnetic energy substantially within the visible spectrum, and to convert that energy into an electronic signal which can be further processed. The electronic signal is digitized for storage to a memory or storage device. The stored digitized image can be further processed and can be generated on display 58, and can be processed in the manner discussed in more detail below. Flash 72 can activate to provide additional lighting to assist the capture of energy by optical capture 76. In general, it is to be understood that optical capture unit 76 can if desired, be implemented or based on a digital camera function as commonly incorporated into portable electronic devices such as cellular telephones.

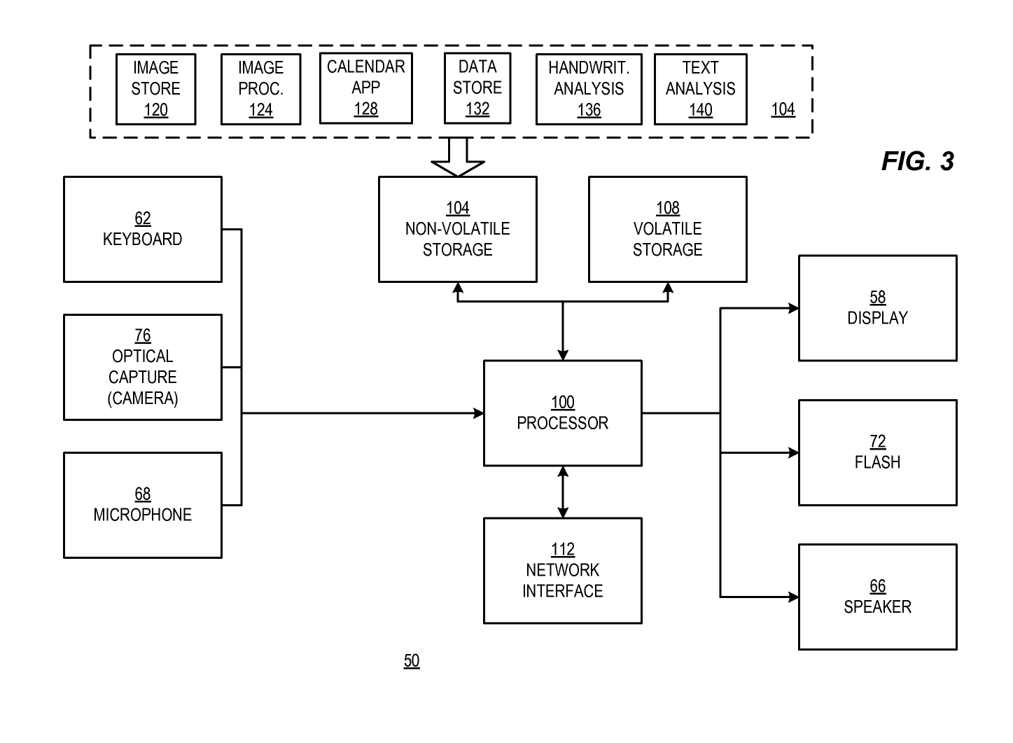

FIG. 3 shows an example of a schematic block diagram of the electronic components of one example implementation of device 50. It should be emphasized that the structure in FIG. 3 is an example and not to be construed as limiting. Device 50 includes a plurality of input devices which in a present example embodiment includes keyboard 62, microphone 68, in addition to optical capture unit (digital camera) 76. Other input devices may also be included. Input from keyboard 62, microphone 68 and optical capture unit 76 is received at a processor 100. Processor 100, which may include one or more processors, can be configured to execute different programming instructions that can be responsive to the input received via input devices. To fulfill its programming functions, processor 100 is also configured to communicate with a non-volatile storage unit 104 (e.g. Erase Electronic Programmable Read Only Memory (“EEPROM”), Flash Memory) and a volatile storage unit 108 (e.g. random access memory (“RAM”)). Programming instructions that implement the functional teachings of device 50 as described herein can be maintained, persistently, in non-volatile storage unit 104 and used by processor 100 which makes appropriate utilization of volatile storage 108 during the execution of such programming instructions.

Processor 100 in turn is also configured to display images on display 58, control speaker 66 including associated audio circuitry (not shown) and flash 72, also in accordance with different programming instructions and optionally responsive to inputs received from the input devices.

Processor 100 also connects to a network interface 112, which can be implemented in a present example embodiment as a radio transceiver configured to communicate over a wireless link (e.g., a cellular telephone link), although in variants device 50 can also include a network interface for communicating over a wired link. Network interface 112 can thus be generalized as a further input/output device that can be utilized by processor 100 to fulfill various programming instructions. It will be understood that interface 112 is configured to correspond with the network architecture that defines such a link. Present, commonly employed network architectures for such a link include, but are not limited to, Global System for Mobile communication (“GSM”), General Packet Relay Service (“GPRS”), Enhanced Data Rates for GSM Evolution (“EDGE”), 3G, High Speed Packet Access (“HSPA”), Code Division Multiple Access (“CDMA”), Evolution-Data Optimized (“EVDO”), Institute of Electrical and Electronic Engineers (IEEE) standard 802. 11, Bluetooth™ or any of their variants or successors. Each network interface 112 can include multiple radios and antennas to accommodate the different protocols that may be used to implement different types of links.

As will become apparent further below, device 50 can be implemented with different configurations than described, omitting certain input devices or including extra input devices, and likewise omitting certain output devices or including extra input devices. However, a common feature of any device 50 used to implement the teachings of this specification includes optical capture unit 76 and accompanying processing and storage structures.

In certain example embodiments, device 50 is also configured to maintain, within a non-volatile storage device such as flash memory 104, an image store 120, an image processing application 124, an executable calendar application 128, and a data record store 132 for storing data records compatible with the executable calendar application 128. As will be explained further below, any one or more of image store 120, image processing application 124, calendar application 128, and data record store 132 can be pre-stored in non-volatile storage 104 upon manufacture of device 50, or downloaded via network interface 112 and saved on non-volatile storage 104 at any time subsequent to manufacture of device 50.

Processor 100 is configured to execute image processing application 124 and executable calendar application 128, making use of the image store 120 and data record store 132 as needed. In one general aspect of certain example embodiments, as will be explained further below, processor 100 is configured, using image processing application 124, to optically capture a reference and an image via optical capture unit 76, and use pattern matching (for example) to match the image with a calendar image so that individual data for each day can be separated out.

Processor 100 is also configured to carry out handwriting analysis using a handwriting analysis program module 136 that may form a part of the calendar application or the image processing application to convert the written information on a written calendar to data that can be automatically populated (i.e., automatically inserted) into fields of the electronic calendar and stored as data to the data record store 132. Additionally, the handwriting analysis module 136 may pass recognized text to a text analysis module 140 for analysis of the content of the text in order to appropriately place the text into fields of the electronic calendar 128. Non-limiting, example implementations of this general aspect will be discussed in further detail below. Memory/storage device 104 can also contain other programs, apps, operating system, data, etc.

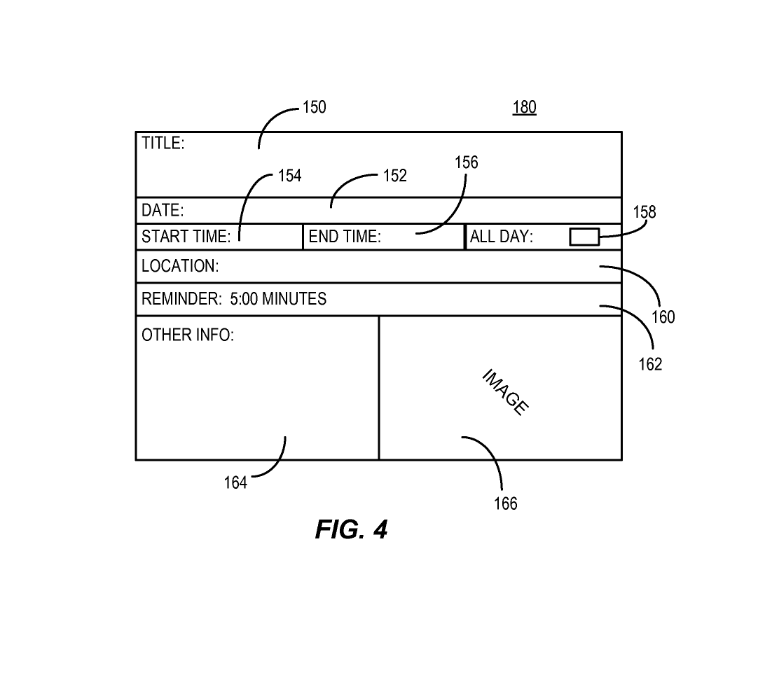

With reference to FIG. 4, an example embodiment of the electronic calendar 128 can store various information associated with dates that can then be tracked, displayed, searched and otherwise utilized by a user. In accord with one example, the user may be able to utilize the calendar as a conventional calendar combined with a database management tool, where each date can be considered (for purposes of illustration and not by way of limitation) a record with each record having fields such as title 150, date 152, start time 154, end time 156, designation of an all day event 158, a location 160, a reminder time interval 162 (shown with a user changeable default time interval for a warning of 5:00 minutes prior to the event) and a general information (other information) field 164. In certain example implementations, a field that contains a reference to or an actual image can also be provided, shown here as 166. These fields are shown in FIG. 4 in the form of a template 180 that can be displayed on display 58 and used as a guide for a user to enter data relating to a particular calendar event that is to be tracked on the electronic calendar 128. This template may also be used as a mechanism for presentation of a particular calendar entry's details to a user for complete understanding of the event as stored in the electronic calendar 128. This template and these specific fields are not intended to be limiting as other calendar arrangements may be employed having more or fewer or different calendar fields.

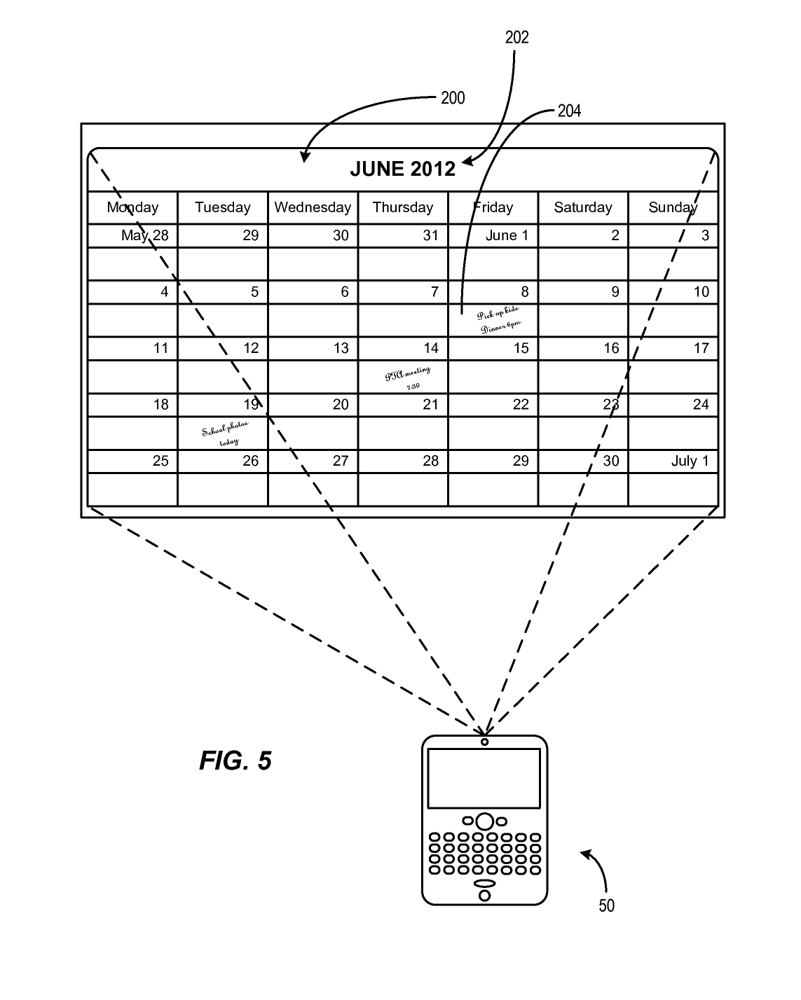

In accord with certain example implementations consistent with the present teachings, the device 50 can be utilized as a digital camera to capture to memory (storage) a digital image of a written calendar 200 such as a family calendar in order to provide for further processing as depicted in FIG. 5. In general, such a written calendar may be arranged as an array of cells seven columns wide with four to six rows. Each cell generally contains indicia that can be utilized to ascertain by image analysis the calendar dates, such as a number appearing in a consistent location of each cell representing a day. The calendar 200 also may include indicia (or hand written entries) such as block text 202 (indicating “JUNE 2012”) that identify month and year. The calendar can be recognized, either by manual entry by the user or by image analysis, as containing a calendar grid representing days and dates of a conventional written calendar. In some example implementations, a particular calendar format may be utilized to facilitate recognition of the calendar as a calendar by the processor 100, while in other example implementations an analysis by processor 100 is undertaken to identify characteristics of a calendar as being that of a written calendar, and in still other example implementations manual intervention is used to designate that a calendar is to be processed. Combinations of the above are also possible.

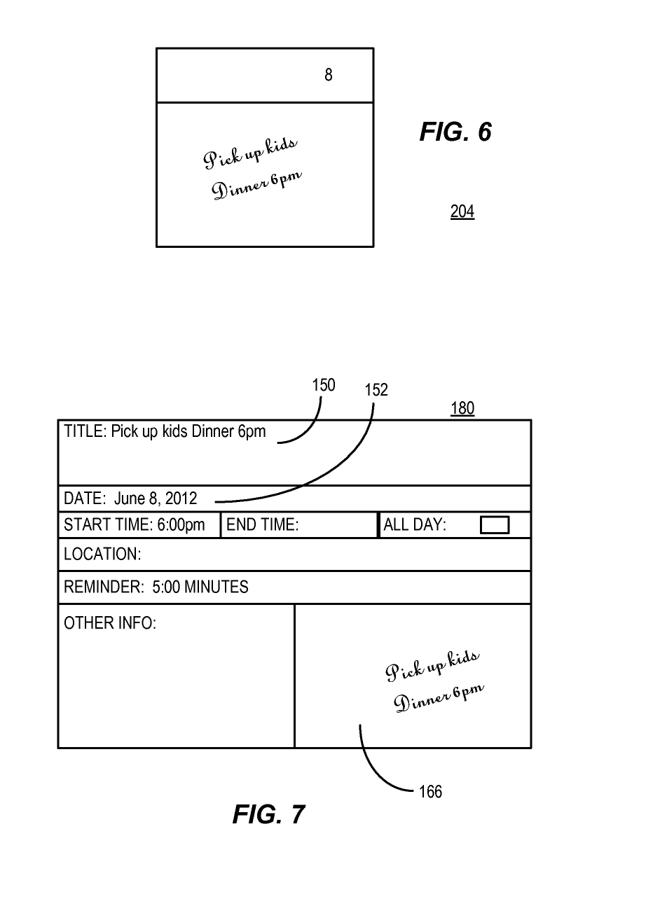

Once the image is captured, the processor 100 uses image processing application 124 to determine that certain areas of the calendar's grid structure are empty while others have handwritten or other entries (including cells that contain no text or handwriting, but have information in pictorial or other form that represents a calendar event to the user). In this example calendar depicting June of 2012, there are written entries on only three days—June 8, 14 and 19, for purposes of illustration. For purposes of an illustrative example, consider the entry 204 of June 8, 2012 which is shown in isolation in FIG. 6 as 204. In this illustrative example, a handwritten calendar entry is depicted which reads “pick up kids Dinner 6 pm”. In this example, the processor 100 recognizes non-empty cell for June 8 and using handwriting analysis module 136 analyses the image within the calendar cell corresponding to June 8 to convert the handwritten information to text that can be more readily analyzed by text analysis module 140. In other instances when the image constituting the calendar entry is block text rather than handwritten text, the processor 100 may instead employ an optical character recognition (OCR) process before the text analysis module 140. Regardless the image analysis is performed in order to automatically place the information into an appropriate field of the electronic calendar as data (i.e., automatically populate the calendar field). This is depicted in FIG. 7 as having been automatically entered into the template.

In this particular example, it may be unclear if this particular entry is actually one entry or two. That is, does the entry mean that the kids are to be picked up for dinner at 6:00 pm, or is there an understanding as to the time when the kids are to be picked up that need not be entered into the calendar, and dinner at 6:00 pm is a separate entry? As a first pass, in some implementations it may be assumed that each date has but a single entry and those entries that need to be separated can be managed by the user manually. In other applications, entries such as “pick up kids” may be set up as a regularly scheduled entry that has associated time, location, etc. associated therewith that can be automatically populated into the electronic calendar fields with known times and other parameters.

In this example, the text analysis module 140 identifies that the start time 154 is 6:00 pm and the date is June 8, 2012 (152), but in the absence of other information has no end time or other data. In certain implementations, all information that cannot clearly be placed into a particular field associated with a particular date may be either aggregated or combined into the title field or the other info field. It is also useful, but not required, that the electronic image as captured be available for reference at 166 should the user need to make corrections as a result of errors in handwriting analysis or categorization of entries into the appropriate fields of the calendar entry, or in the event there are graphics that are relevant or desired to be available (e.g., a restaurant logo or photograph).

In certain example implementations, when an image of a written calendar 200 is taken, the calendar image can be analyzed cell by cell to identify cells in the calendar that are populated by hand written calendar information (or otherwise populated—e.g., with a photograph or other information). In one example implementation, the first time a particular calendar is photographed, each populated cell is processed and the user is given the opportunity to edit each entry, e.g., using the template 180, and then the method proceeds through each populated calendar cell until all entries have been manually verified. When this calendar is photographed a second time, if the processor 100 can determine that an entry has already been processed (e.g., by comparison or reconciliation with another image stored for that date or by noting identical or similar calendar entries in the populated fields), that image can be skipped so that only new or modified entries are verified manually.

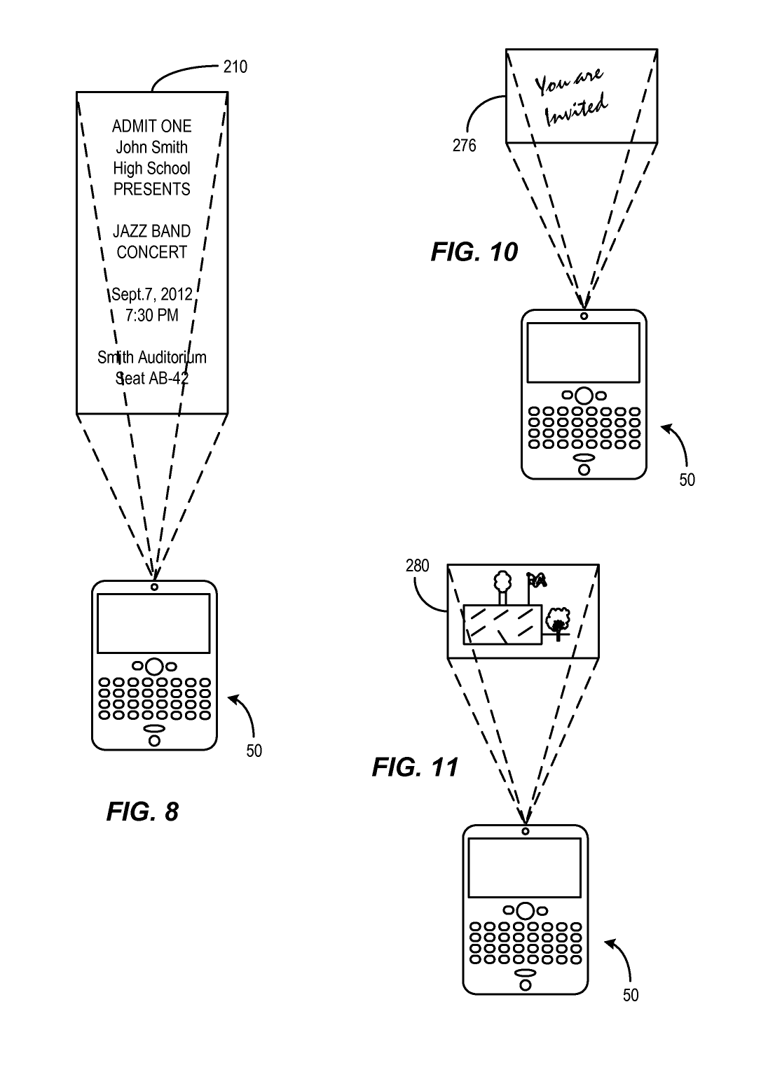

In certain example embodiments, other objects can represent written calendar entry documents that convey information that can easily be captured for a calendar entry. One example is depicted in FIG. 8 in the form of a concert ticket 210. Other examples include, but are not limited to, posters, signs, graphics, symbols, photographs, business cards, appointment cards, invitations, announcements, and the like that contain information that convey temporal information that can easily be captured for a calendar entry. This ticket 210, while not a calendar event per se, has information that a user may wish to enter into an electronic calendar. In fact, the user may well attach the ticket 210 to the written calendar 200 on the date associated with the event for which the ticket was purchased using a magnet, push pin or other mechanism. As depicted, the ticket can be treated much like a written calendar event on a calendar (and in fact may be attached to the written calendar) by photographing the ticket 210 using device 50 to produce an image of the ticket 210 for manipulation by the processor 100.

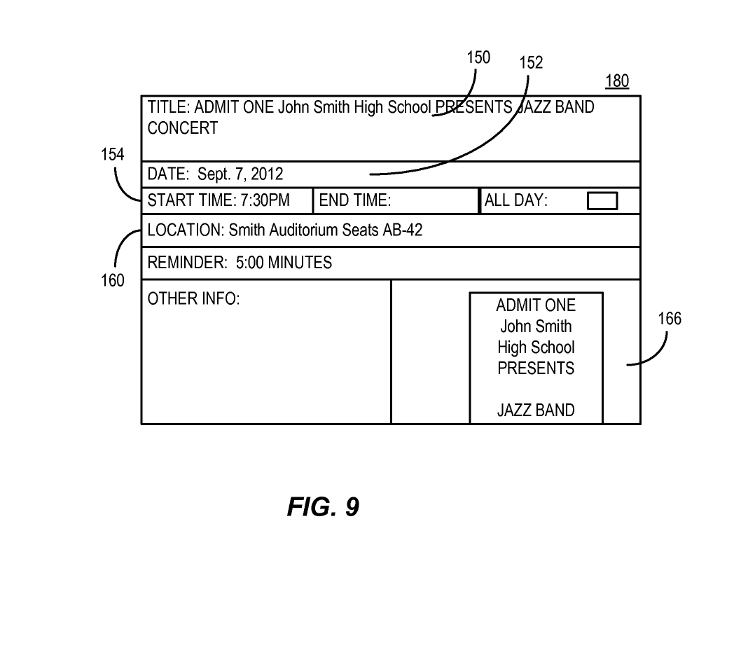

Using text recognition processing, the text content of the ticket can be captured and parsed into data elements that can then automatically populate the appropriate fields of the electronic calendar 128 by inserting data determined to be associated with a particular field into that field. This is depicted in one example in FIG. 9 where the date is captured and automatically inserted into the date field 152 and the start time is automatically inserted into the start time field 154. The location may be similarly deduced (e.g. using heuristics) by the text processing module knowing (or learning or being designated by the user) that an auditorium is a place. The initial information that is not recognizable as any other distinct field is placed in the title field 150 in this example and the image appears at window 166. (Information that cannot be reliably identified can be populated to the title or the other information fields in various example embodiments.) The image is shown truncated and can be scrolled or zoomed as desired to see the image. Other variations will occur to those skilled in the art upon consideration of the present teachings.

In other examples, such as that depicted in FIG. 10, the user may wish to calendar a party invitation 276 or the like to the electronic calendar. In this example, an invitation may have text on the outside that is relatively uninformative for purposes of the calendar since it includes no date information. But, the user may wish to associate this image with the invitation. In this case, when the processor 100 analyzes the image of the front of the invitation, it may recognize “you are invited”, but has no information from which to derive a date. A second image may be captured of another page of the invitation in order to provide further data for analysis, or the method can display a query (e.g., a pop-up window querying the user for a date) and/or may display the calendar data template to allow the user to manually provide data for entry into the calendar. In one example, the query may request another image or user input, either of which can be selected to provide the information used to calendar the event in the electronic calendar.

Similarly, in the case of an appointment such as a doctor appointment, the user may take an image of the doctor's business card. This card may have all of the information needed to automatically populate a calendar entry except for the basic information of a date and time. When the text on the business card is recognized but no date information is provided, the processor similarly can provide a query, pop-up, template or otherwise request the date and time information for the calendar. Upon user entry of the date and time manually, the method can proceed with saving the fully populated calendar event.

A further example is provided in FIG. 11 in which the user takes a photograph that captures an electronic image that contains no recognizable text. In this example, the image may be a photograph of a post card, hard copy photograph, or any other image. However, since the image contains no text or handwriting, in order to convert the image to a calendar event, the user is posed with a query, template, pop-up window, etc. in order for the user to manually associate the date with a calendar entry. In this case, for example, if the image is of a school, the calendar event may be “first day of school” with accompanying date and time entries and other relevant information as the user sees fit, that the user can manually supply in order to populate the electronic calendar with the calendar event.

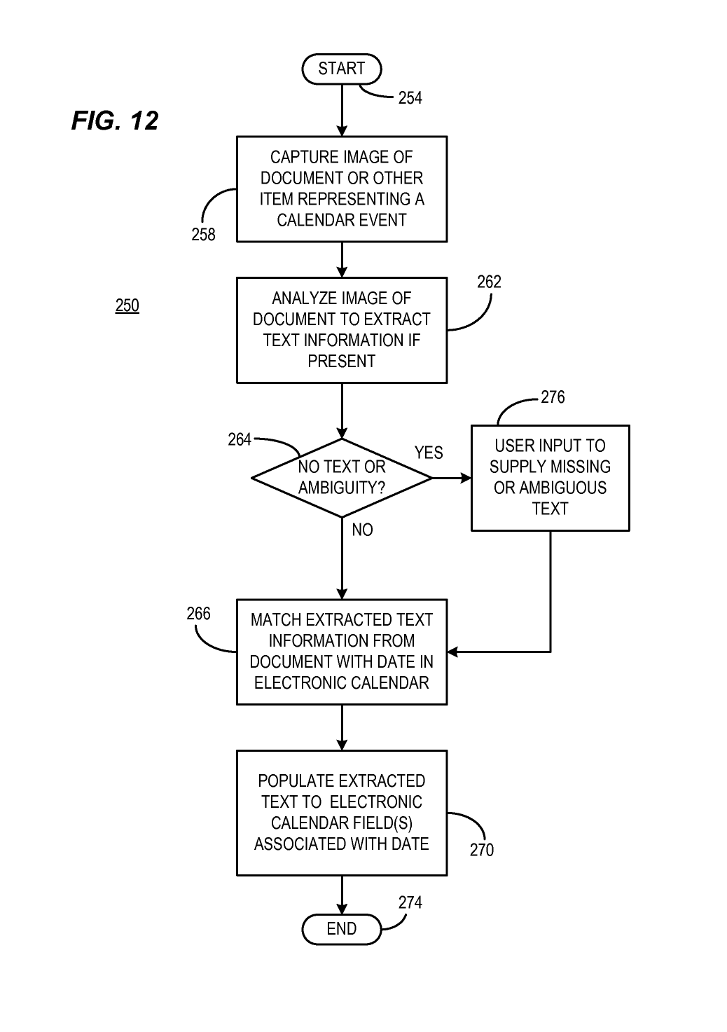

FIG. 12 depicts an example method 250 starting at block 254 in which a method of entering calendar events into an electronic calendar involves an operation of capturing a digital image of a document that contains a written calendar event or other information (images, symbols, etc.) representing a calendar event at block 258. At block 262, the method proceeds with analyzing the digital image of the document containing the written calendar event to extract text information, if any, appearing on the digital image of the document. At block 262 if there is text information present, at block 264 the text is extracted. At block 266, the method proceeds with matching the extracted text information in the digital image of the written calendar event document to a date in the electronic calendar 128. The method then progresses to block 270 with automatically populating (inserting) the extracted text information to at least one field of the electronic calendar 128 associated with the date. The method ends at block 274.

In the event no text information is present relative to block 262 or when there is an ambiguity or problems with handwriting recognition or text analysis at block 264, the user can be provided with a query or template at block 276 in order to determine the date the captured image is associated with or resolve any ambiguities or provide missing data in general.

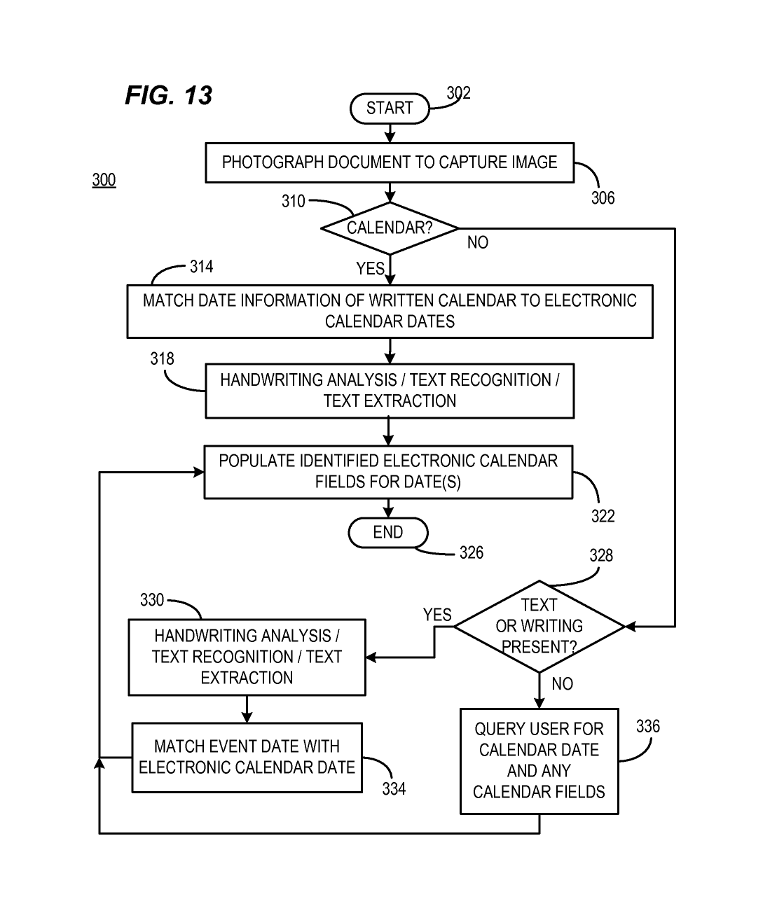

Referring now to FIG. 13, an example method 300 is depicted starting at block 302 in which a document containing a calendar event is photographed in order to capture a digital image thereof at block 306. Either before or after electronically capturing the image, a determination can be made at block 310 as to whether or not the captured image is that of an actual written calendar or of another document containing an event to be entered into the electronic calendar 128. This can be done in a number of ways including a query after the image is taken, a query before the image is taken, a designation prior to taking the image or by automatically analyzing the image to ascertain whether or not it appears to be a calendar or contains information suitable for entry into an electronic calendar. Any of the above example variants and combinations thereof may be employed.

If the image is determined to be that of a written calendar at block 310, then the date information in the written calendar is matched with dates in the electronic calendar 128 at least for those dates having written entries associated therewith at block 314. For at least those dates having written entries (and in certain implementations only for those written entries that are detected to be new written entries or modified written entries since this method 300 was last carried out) an analysis is carried out at block 318 in which the handwriting is analyzed and converted to text that is then recognized and parsed to extract or categorize text that appears to be associated with electronic calendar fields. The text is then automatically populated into fields that appear from the analysis to correspond to electronic calendar fields at block 322. This method may involve manual intervention in any suitable manner to resolve any ambiguity or other difficulty encountered either in machine recognition of handwriting or in categorizing text to appropriate fields at any point before the method ends at block 326.

In the event, at block 310, that the image is determined to not be a written calendar, but to otherwise contain information that is suitable for entry (or which the user desires to use to represent a calendar event) into the electronic calendar 128, a determination is made at block 328 as to whether any recognizable text or handwriting appears to be present. If so, an example method is carried out at block 330 that operates in a manner similar to that of block 318. In block 330, the method recognizes handwriting if the document appears to contain handwriting and otherwise or in addition carries out a text recognition method that not only extracts text that appears to correspond to the various fields of the electronic calendar 128, but also searches for a date or dates that are associated with an event described in the document. This event date is then matched with an electronic calendar date at block 334 and the method proceeds to block 322 where an electronic calendar date record is automatically populated with text that is extracted from the document so as to provide an electronic calendar entry. As with the case of an electronic calendar entry per se, this method may involve manual intervention in any suitable manner to resolve any difficulty or ambiguity encountered either in machine recognition of handwriting or in categorizing text to appropriate fields at any point before the method ends at block 326.

In the event no text or handwriting is found or recognized at block 328 (e.g., in the event the image is a photograph of a person or other meaningful image, or in the event no recognizable or meaningful text or handwriting is identified), control passes to block 336 where the user is queried (e.g., using a pop-up window or displaying the calendar data template) in order to provide the user with an opportunity to provide date and other calendar information to associate with the image. Control then returns to block 322 where the date are inserted into appropriate fields of the electronic calendar. The method ends at block 326.

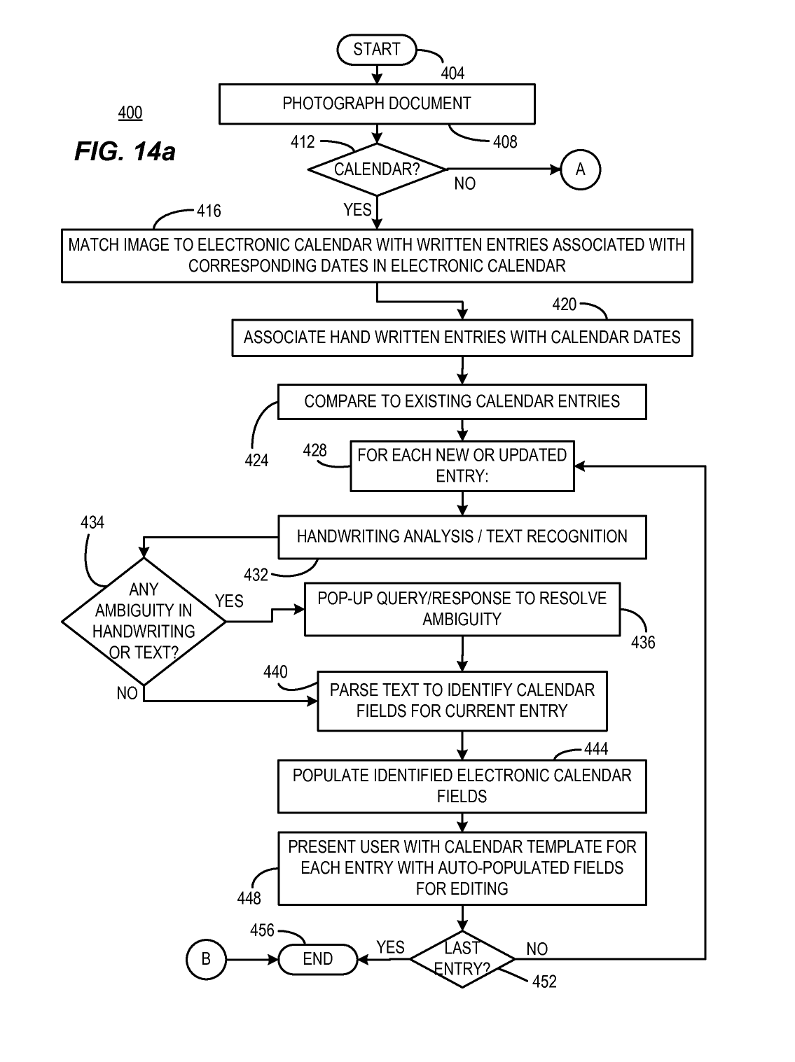

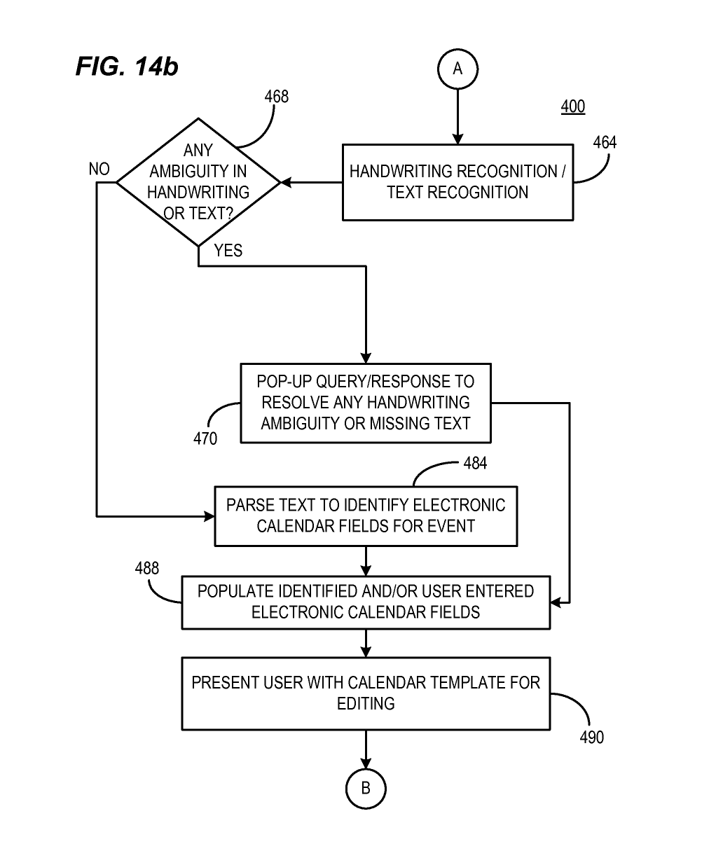

FIG. 14, which includes FIG. 14a and FIG. 14b, depicts another, and more detailed method 400 consistent with certain example embodiments starting at block 404 after which a document is photographed at block 408 to produce a digital image. Either before or after electronically capturing the image at block 408, a determination can be made as to whether or not the image being captured is that of an actual written calendar or of another document containing an event to be entered into the electronic calendar 128 at block 412. This determination can be done in a number of ways including a query after the image is taken, a query before the image is taken, a designation prior to taking the image or by automatically analyzing the image to ascertain whether or not it appears to be a calendar or contain information suitable for entry into an electronic calendar. Any of the above examples may be employed.

If the image is determined to be that of a written calendar at block 412, then the date information in the written calendar is matched with dates in the electronic calendar 128 at least for those dates having written entries associated therewith at block 416. Hand written entries for each date having such entries are then associated with electronic calendar dates at block 420. In the present example implementation, the identified entries are compared at block 424 with any existing calendar entries so that written calendar entries that are old and unchanged (i.e., have already been processed by this or similar method previously) do not get reprocessed and only new written entries or entries that are updated and differ from a prior entry are processed. At block 428, for each new or updated entry the new or updated entry is processed first by handwriting analysis (assuming it is a handwritten entry) and text recognition at block 432. If any ambiguities are encountered at block 434 in the handwriting analysis or text recognition in the method of reading the handwriting and converting it to text at block 432, such ambiguities are resolved at block 436 by user intervention. In this example, a pop-up window can be displayed that queries the user for assistance. The user can refer to the written calendar or can refer to an image thereof on the display 58 in certain example embodiments and can resolve the handwriting ambiguity or uncertainty, after which the method can proceed to block 440 where the text is analyzed and parsed into calendar fields for the current calendar entry. Each segment of text parsed at block 440 to correspond to an electronic calendar field is then automatically populated to the electronic calendar's corresponding fields at block 444. If no ambiguities are identified at block 434, control passes to block 440 while bypassing block 436.

In certain example implementations, each entry can then be presented to the user in the form of a template containing the entry as populated to the date record so that the user can either accept the entry or edit it as desired for the current entry at block 448. If the last entry has been encountered at block 452, the method ends at block 456. Otherwise, the method proceeds to the next identified event by returning to block 428 to repeat this method for each entry.

In the event the document is determined at block 412 by any suitable mechanism to not be a calendar per se, the method proceeds from block 412 to block 464 (FIG. 14b). For purposes of this example, it is presumed that a non-calendar document contains only a single calendar entry, but this method can readily be modified to increment as depicted previously to iterate through multiple detected calendar events if desired without limitation. At block 464, handwriting can be converted to text and the text recognized, or if there is no handwriting to be recognized, processed directly as text at block 464. If an ambiguity or other difficulty is detected or if the processor 100 is unable to read an element of handwriting at block 468 or otherwise complete the processing (or if there is no text in the image), the user may again be presented with a pop-up window that requests the user to intervene and clarify the ambiguity at block 470. At block 468, such ambiguity can include the instance where the image in fact contains no identifiable handwriting or text (e.g. where the image is an image of a photograph), or inadequate information at block 464 that can be used to either identify a date or to fill in fields of the electronic calendar. Such fields can then be filled at block 488.

At block 484, when there are no ambiguities identified at block 468, the text is parsed into text segments that include date information and other information that are recognized by the processor 100 as being associated with fields in the electronic calendar 128 for the event described in the current document. The identified electronic calendar fields are then automatically populated at block 488. The user can then be presented with the calendar template in order to verify and edit the automatically populated data as desired at block 490 before the method ends at 456 (FIG. 14a). Many variations will occur to those skilled in the art upon consideration of the present teachings.

In cases described above in which handwriting recognition or text recognition is carried out, these processes can utilize any technique including conventional techniques that involve text or writing alignment and recognition of individual characters as well as evaluation of combinations of characters that form words and phrases that can also be accumulated to a dictionary for future identification. Moreover, learning algorithms can be implemented so that an individual's handwriting can become more easily recognized with each iteration of the handwriting. Additionally, while it is useful to recognize a calendar itself by the pattern of an array of cells, a special calendar having specialized indicia that is more readily recognized by other processes may be utilized without limitation. Many variations will occur to those skilled in the art upon consideration of the present teachings.

The order in which the optional operations represented in various blocks of the flow charts may occur in any operative order. Thus, while the blocks comprising the methods are shown as occurring in a particular order, it will be appreciated by those skilled in the art that many of the blocks are interchangeable and can occur in different orders than that shown without materially affecting the end results of the methods.

The implementations of the present disclosure described above are intended to be examples only. Those of skill in the art can effect alterations, modifications and variations to the particular example embodiments herein without departing from the intended scope of the present disclosure. Moreover, selected features from one or more of the above-described example embodiments can be combined to create alternative example embodiments not explicitly described herein.

It will be appreciated that any module or component disclosed herein that executes instructions may include or otherwise have access to non-transitory and tangible computer readable media such as storage media, computer storage media, or data storage devices (removable or non-removable) such as, for example, magnetic disks, optical disks, or tape data storage, where the term “non-transitory” is intended only to exclude propagating waves and signals and does not exclude volatile memory or memory that can be rewritten. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server, any component of or related to the network, backend, etc., or accessible or connectable thereto. Any application or module herein described may be implemented using computer readable/executable instructions that may be stored or otherwise held by such computer readable media.

The present disclosure may be embodied in other specific forms without departing from the teachings herein. The described example embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method of managing an electronic calendar, comprising:
capturing a digital image associated with a calendar event;
using a processor to analyze the digital image to determine if the digital image contains text information and if so to extract the text information appearing in the digital image;
the processor further determining whether at least a part of the text information matches a date; and
when text information is extracted and at least part of the extracted text information matches a date in the electronic calendar, the processor inserting the extracted text information to at least one field of the electronic calendar associated with the date.

2. The method according to claim 1, further comprising:
when text information is not extracted, the processor causing a display to display a query to request identification of the date in the electronic calendar to which the digital image is associated.

3. The method according to claim 1, further comprising:
when at least part of the extracted text information does not match a date in the electronic calendar, the processor causing a display to display a query to request identification of the date in the electronic calendar to which the digital image is associated.

4. The method according to claim 1, where the digital image represents a document bearing a written calendar and where the matching comprises associating a written calendar entry associated with a date of the written calendar with a field associated with a matching date in the electronic calendar.

5. The method according to claim 1, further comprises the processor causing a display to display a query to request manual identification of text that is not recognized in the written calendar event.

6. The method according to claim 1, where the analyzing comprises carrying out handwriting analysis to extract text from handwriting.

7. The method according to claim 1, further comprising the processor causing a display to display a template for manual entry of data associated with the date in the electronic calendar.

8. The method according to claim 6, further comprising storing in a memory the captured digital image or a link thereto to an image field of the electronic calendar, and where the captured digital image is displayed in the template for reference in carrying out manual entry of data associated with the date in the electronic calendar.

9. The method according to claim 1, further comprising storing in a memory the captured digital image or a link thereto to an image field of the electronic calendar.

10. A device, comprising:
a storage device;
a digital camera configured to capture a digital image and store the captured digital image to the storage device; and
a programmed processor having access to the storage device and configured to:
analyze the digital image to determine if the digital image contains text information and if so to extract the text information appearing in the digital image;
determine whether at least a part of the text information matches a date;
when text information is extracted and at least part of the extracted text information matches a date in an electronic calendar, insert the extracted text information to at least one field of the electronic calendar associated with the date.

11. The device according to claim 10, further comprising:
where the processor is further configured to cause display of a query to request identification of the date in the electronic calendar to which the digital image is associated when a date is not extracted.

12. The device according to claim 10, further comprising:
where the processor is further configured to:
when at least part of the extracted text information does not match a date in the electronic calendar, display a query to request identification of the date in the electronic calendar to which the digital image is associated.

13. The device according to claim 10, where the captured digital image represents a document bearing a written calendar and where the matching comprises associating a written calendar entry associated with a date of the written calendar with a field associated with a matching date in the electronic calendar.

14. The device according to claim 10, where the processor is further configured to cause display of a query to request manual identification of text that is not recognized in the written calendar event.

15. The device according to claim 10, where the analyzing comprises carrying out handwriting analysis to extract text from handwriting.

16. The device according to claim 10, where the processor is further configured to cause display of a template for manual entry of data associated with the date in the electronic calendar.

17. The device according to claim 16, where the processor is further configured to cause storage of the captured digital image or a link thereto to an image field of the electronic calendar, and where the captured digital image is displayed in the template for reference in carrying out manual entry of data associated with the date in the electronic calendar.

18. The device according to claim 10, where the processor is configured to cause storage of the captured digital image or a link thereto to an image field of the electronic calendar.

19. A device, comprising:
a storage device;
a digital camera configured to capture a digital image and store the captured digital image to the storage device; and
a programmed processor configured to:
analyze a digital image of a document that includes a written calendar event to extract text information appearing in the digital image;
determine whether or not the document comprises a written calendar;
match the extracted text information in the digital image to a date in the electronic calendar, where if the document does not comprise a written calendar the matching comprises finding text that identifies the calendar date, and where the at least one field of the electronic calendar is populated with at least a portion of the extracted text, and where if the document does comprise a written calendar the matching comprises associating a written calendar entry associated with a date of the written calendar with a field associated with a matching date in the electronic calendar; and
insert the extracted text information to at least one field of the electronic calendar associated with the date.

20. The device according to claim 19, where the processor is further configured to display a query to request manual identification of text that is not recognized in the written calendar event.

21. The device according to claim 19, where the analyzing comprises carrying out handwriting analysis to extract text from handwriting.

22. The device according to claim 19, where the processor is further configured to cause display of a template for manual entry of data associated with the date in the electronic calendar.

23. The device according to claim 19, where the processor is configured to cause storage of the captured digital image or a link thereto to an image field of the electronic calendar.
